(19) United States
(12) Patent Application Publication
(10) Pub. No.: US 2007/0014626 A1
(43) Pub. Date: Jan. 18, 2007

(54) Interactive package for a writing instrument

(76) Inventor: Dennis Claussen, Venice, CA (US)

Correspondence Address: TOPE-MCKAY & ASSOCIATES, 23852 PACIFIC COAST HIGHWAY #311, MALIBU, CA, 90265, US

(21) Appl. No.: 11/181,679

(22) Filed: Jul. 13, 2005

(51) Int. Cl. B65D 69/00; B43K 1/10

(52) U.S. Cl. 401/258; 206/815; 206/224

(57) ABSTRACT

An interactive package for a writing instrument to allow a user to grip the writing instrument when the writing instrument is mounted in the package. The interactive package contains a back support connected with a mount, the mount having indentations to mount the writing instrument away from the back support so that the writing instrument appears to float inside the interactive package. An outer shell connects with the back support and surrounds the mount to create a compartment. Two openings in the outer shell allow a user to insert a finger and thumb through the respective openings to grip the writing instrument without touching any portion of the package. The user can then test the weight, look, and feel of the writing instrument while the writing instrument remains protected in the enclosure.

### BACKGROUND OF THE INVENTION

(1) Field of Invention

The present invention relates to packaging for a writing instrument and, more particularly, to an interactive package for a writing instrument that allows a user to grasp the writing instrument without removing it from the packaging.

(2) Description of Related Art

Packaging for a writing instrument is typically a box-shaped container holding the writing instrument therein. In some cases, the container is formed of a clear material, allowing a user (e.g., potential customer) to view the contents of the container. In such containers, should the user decide to touch or feel the writing instrument, the user is required to open and remove the writing instrument from the container.

For retailers, opened containers pose a problem as the opened container may exhibit wear from being opened. Additionally, a packaging container exhibiting wear often dissuades another customer from purchasing that particular product, resulting in discounted prices and/or unsold products.

Thus, a continuing need exists for an interactive package for a writing instrument that allows a user to touch and feel the writing instrument without removing the writing instrument from the packaging.

### SUMMARY OF INVENTION

The present invention is related to an interactive package for a writing instrument. The interactive package comprises a back support with a first end and a second end. An outer shell is connected with the back support to define a compartment in combination with the back support. A mount is positioned in the compartment for supporting a writing instrument. The mount comprises a first portion and a second portion, and the writing instrument comprises a writing end and a non-writing end. The first portion of the mount is formed to mount the non-writing end of the writing instrument and the second portion of the mount is formed to mount the writing end of the writing instrument. The outer shell encloses the mount and supported writing instrument to securely protect the writing instrument. Additionally, the outer shell includes an opening configuration sized and shaped to permit a user's fingers to enter the compartment and grasp the writing instrument.

In another aspect, the opening configuration includes two openings sized and shaped to permit a finger and a thumb of a user to enter and grasp the writing instrument without otherwise substantially touching the outer shell, mount, or back support.

In yet another aspect, the back support further comprises a hanging mechanism connected with the first end for hanging the package on a shelf.

Additionally, the back support is formed of a material selected from a group consisting of plastic, paper, or cardboard.

Furthermore, the back support is made from a clear plastic.

In yet another aspect, the mount is formed to frictionally fit between the back support and the outer shell.

Additionally, the mount is formed in a triangular shape.

In another aspect, the first portion of the mount and second portion of the mount are formed separately, and wherein the first portion of the mount is connected with the first end of the back support, and wherein the second portion of the mount is connected with the second end of the back support.

In yet another aspect, the first portion of the mount further comprises an indentation to frictionally fit the non-writing end of the writing instrument, and wherein the second portion of the mount further comprises an indentation to frictionally fit the writing end of the writing instrument, such that the writing instrument is mounted between the two indentations.

In another aspect, the indentation of the first portion and the indentation of the second portion of the mount are centered between the back support and the outer shell, such that when the writing instrument is mounted it appears to float within the package.

In another aspect, the mount formed of a material selected from a group consisting of plastic, paper, or cardboard.

In yet another aspect, the back support is made from a clear plastic.

In another aspect, the outer shell is formed to frictionally fit the mount.

Additionally, the outer shell is connected with the back support.

Furthermore, the openings in the outer shell are formed in locations that allow a user to grip the writing instrument without substantially touching the package.

In another aspect, both the first portion and the second portion of the mount are connected with the back support.

In another aspect, the back support and the outer shell are integrally formed as a single piece.

Finally, as can be appreciated by one skilled in the art, the present invention also comprises a method for forming the interactive package described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration of an interactive package for a writing instrument according to the present invention, depicting a writing instrument disposed within the interactive package;

FIG. 2 is a left, side-view illustration of an interactive package for a writing instrument according to the present invention, with the writing instrument disposed therein;

FIG. 3 is a front-view illustration of an interactive package for a writing instrument according to the present invention, with the writing instrument disposed therein;

FIG. 4 is a back-view illustration of an interactive package for a writing instrument according to the present invention, with the writing instrument disposed therein; and

FIG. 5 is a top-view illustration of an interactive package for a writing instrument according to the present invention, with the writing instrument disposed therein.

### DETAILED DESCRIPTION

The present invention relates to packaging for a writing instrument and, more particularly, to an interactive package for a writing instrument that allows a user to grasp the writing instrument without removing it from the packaging. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, an introduction is provided to give the reader a general understanding of the present invention. Next, a description of various aspects of the present invention is provided to give an understanding of the specific details.

(1) Introduction

The present invention relates to packaging for a writing instrument. Packaging of the prior art is typically a box-shaped container holding the writing instrument therein. Should a user (e.g., potential customer) decide to touch and/or feel the writing instrument in the prior art packaging, the user is required to remove the writing instrument from the packaging. For retailers, open packaging creates a problem as other potential customers may be dissuaded from purchasing a product with an opened package.

The present invention improves upon the prior art by allowing a user to touch and feel the writing instrument without removing it from the packaging. Through interactive packaging, a retailer can allow a potential customer to gain a better understanding of a product without destroying or damaging the packaging. Thus, the present invention is an interactive packaging with an opening configured therein. The opening is sized and shaped to permit a user's fingers to enter and grasp the writing instrument without otherwise touching the packaging.

(2) The Interactive Package

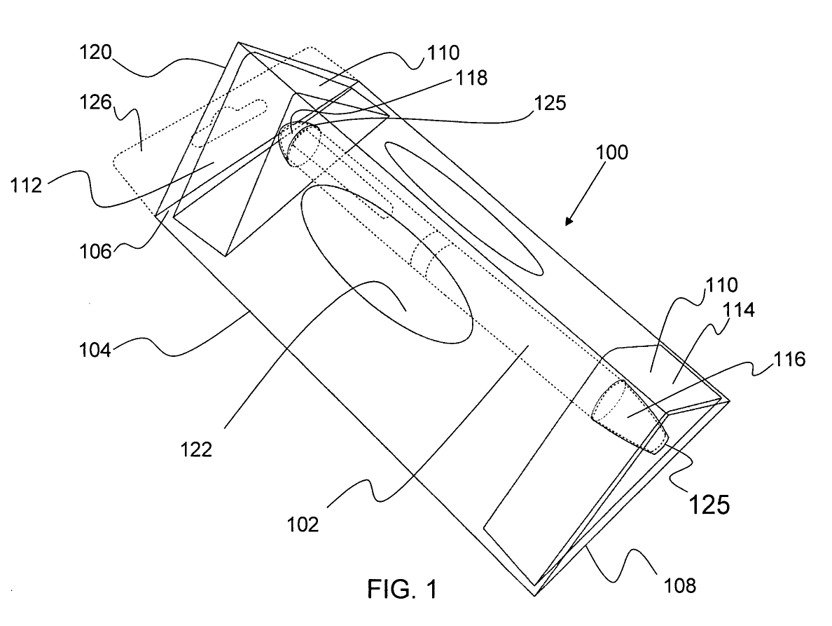

As shown in FIG. 1, the present invention is an interactive package 100 for holding a writing instrument 102 therein. The interactive package 100 includes a back support 104 with a first end 106 and a second end 108. The back support 104 is formed of any suitably durable material, non-limiting examples of which include plastic, paper, and cardboard. In some cases, it may be desirable to form the back support 104 of a clear plastic to allow viewing therethrough.

A mount 110 is included within the interactive package 100 for supporting the writing instrument 102. The mount 110 is formed in any suitable manner to support the writing instrument 102. As a non-limiting example, the mount 110 comprises a first portion 112 and a second portion 114 and the writing instrument 102 comprises a writing end 116 and a non-writing end 118, with the mount 110 formed such that the first portion 112 mounts the non-writing end 118 and the second portion 114 mounts the writing end 116. The mount 110 is formed of any suitably durable material, non-limiting examples of which include plastic, paper, and cardboard. For viewing purposes, it is desirable to form the mount 110 of a clear plastic.

An outer shell 120 is included to cover the mount 110 and a supported writing instrument 102. The outer shell 120 defines a compartment 122 in combination with the back support 104 to securely protect the writing instrument 102. The outer shell 120 and the back support 104 are formed in any suitable manner to define the compartment 122 therebetween. As non-limiting examples, both the outer shell 120 and the back support 104 are formed separately and thereafter attached with each other, and both the outer shell 120 and back support 104 are integrally formed together as a single piece to form the compartment 122 therein. The outer shell 120 is formed of any suitably durable material, non-limiting examples of which include plastic and paperboard. For viewing purposes, it is desirable that the outer shell 120 be formed of a clear plastic.

As can be appreciated by one skilled in the art, the mount 110 can be formed and attached with the interactive package 100 at any suitable location and in any suitable manner so long as the writing instrument 102 is supported by the mount 110. As a non-limiting example, both the first portion 112 and the second portion 114 of the mount 110 are connected with the back support 104. As another non-limiting example, the mount 110 is attached with the outer shell 120. In another aspect, the mount 110 is positioned within the compartment 122 and held in place by the writing instrument 102 and the confines of the compartment 122. In this aspect, the mount 110 is formed to frictionally fit between the back support 104 and the outer shell 120.

As another example, the first portion 112 and second portion 114 of the mount 110 are formed separately from each other, with the first portion 112 being connected with the first end 106 of the back support 104 and the second portion 114 being connected with the second end 108 of the back support 104.

In order to mount the writing instrument 102, both the first portion 112 and the second portion 114 include a writing instrument holder 125 formed therein. The writing instrument holder 125 is any suitable configuration for holding the writing instrument 102. As a non-limiting example, the writing instrument holder 125 is an indentation formed in the respective first 112 and second 114 portions. For example, the first portion 112 includes an indentation formed to frictionally fit the non-writing end 118 of the writing instrument 102 and the second portion 114 includes an indentation to frictionally fit the writing end 116 of the writing instrument 102. In such an aspect, the writing instrument 102 is mounted between the two indentations such that it is held at both ends (i.e., writing end 116 and non-writing end 118).

Although the indentations may be formed at any suitable location within the mount 110, it is desirable that the indentations are formed in the mount such that they are centered between the back support 104 and the outer shell 120. By being centrally mounted, a mounted writing instrument 102 appears to float within the package 100.

To enable a user to touch and feel an attached writing instrument 102, the outer shell 120 includes an opening configuration 124. The opening configuration 124 is sized and shaped to permit a user's fingers to enter and grasp the writing instrument 102 without otherwise substantially touching the outer shell 120, mount 110, or back support 104. For example, the opening configuration 124 includes two openings, sized and shaped to permit a finger and a thumb of a user to enter and grasp the writing instrument 102.

Furthermore, both the back support 104 and outer shell 120 can be formed in any suitable shape to contain a mount 110 therein and enable a user to grasp the writing instrument 102 through the opening configuration 124. As non-limiting examples, the outer shell 120 and the back support 104 come together to form a compartment 122 having a cylindrical shape, a triangular shape, and a rectangular shape. As shown in FIG. 1, the back support 104 is substantially planar with the outer shell 120 forming two outer portions of a triangular shaped compartment 122. In this aspect, the mount 110 is formed in a triangular shape to fit within the compartment 122.

To assist a user in displaying the interactive packaging 100 (and writing instrument therein), the back support 104 comprises a hanging mechanism 126 connected with the first end 106 for hanging the package 100. The hanging mechanism 126 is any suitable mechanism to allow for hanging the package 100, a non-limiting example of which includes a hanging tag.

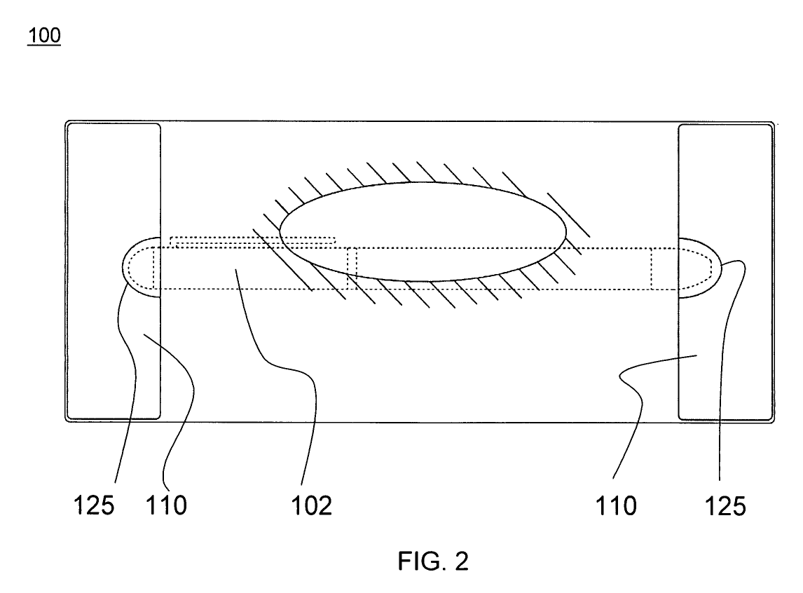

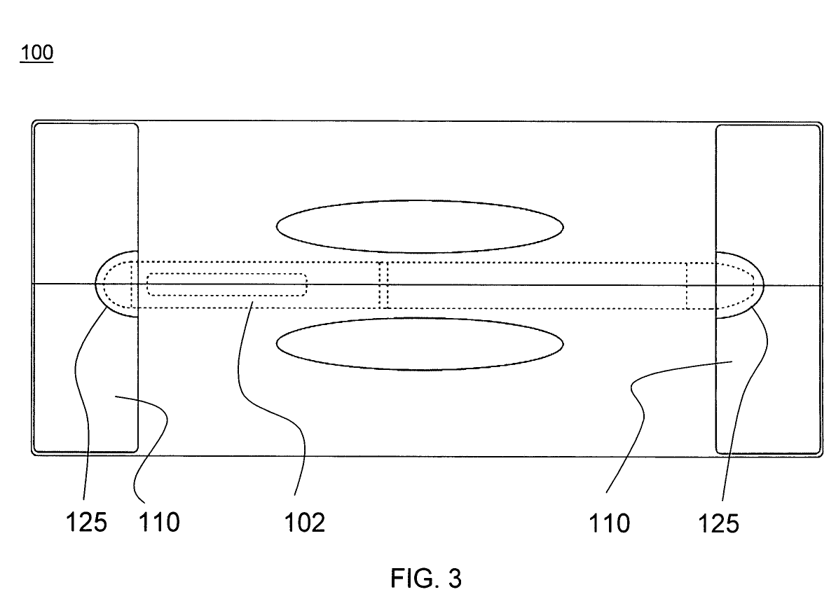

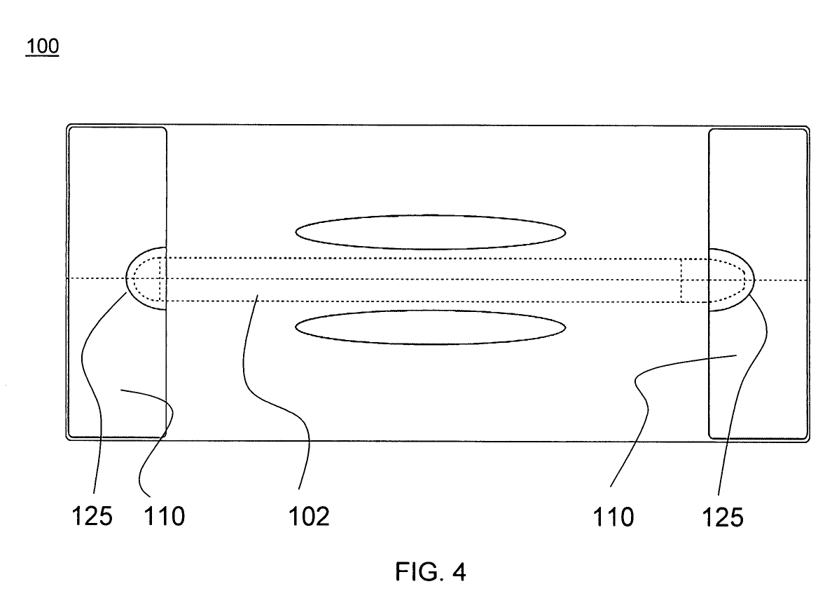

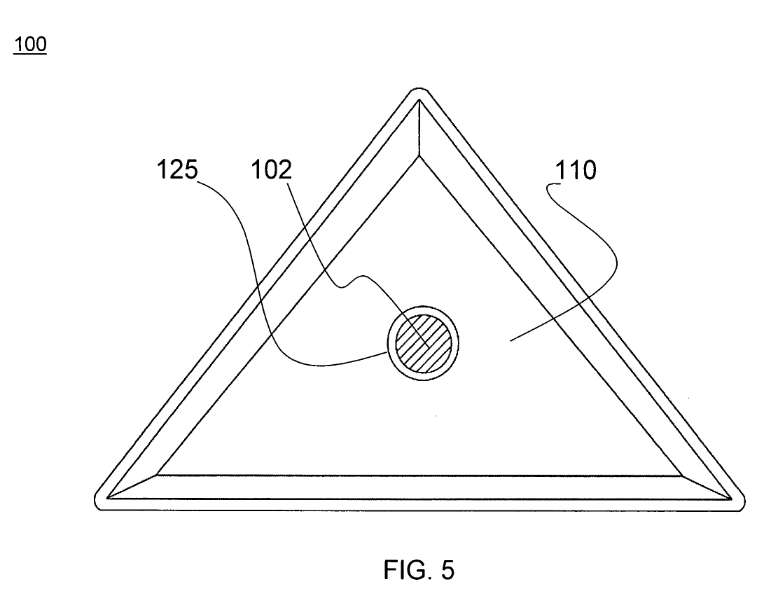

For further illustration, FIGS. 2 through 5 show various view points of the interactive packaging 100. FIG. 2 is a left, side-view illustration; FIG. 3 is a front-view illustration; FIG. 4 is a back-view illustration; and FIG. 5 is a top-view illustration. As seen in FIGS. 2 through 5, the mount 110 includes an indentation-shaped writing instrument holder 125 for holding the writing instrument 102 in place.

As can be appreciated by one skilled in the art, the present invention also comprises a method for forming the interactive package described herein. The method comprises acts of forming a back support with a first end and a second end; connecting an outer shell with the back support to define a compartment in combination with the back support; and positioning a mount in the compartment for supporting a writing instrument. The method further comprises acts of forming each component of the interactive package such that it corresponds with the description of the interactive package described herein.

What is claimed is:

1. An interactive package for a writing instrument, the interactive package comprising:
a back support with a first end and a second end;
an outer shell connected with the back support to define a compartment in combination with the back support;
a mount positioned in the compartment for supporting a writing instrument, wherein the mount comprises a first portion and a second portion, and wherein the writing instrument comprises a writing end and a non-writing end, and wherein the first portion of the mount is formed to mount the non-writing end of the writing instrument, and wherein the second portion of the mount is formed to mount the writing end of the writing instrument; and
wherein the outer shell encloses the mount and supported writing instrument to securely protect the writing instrument, and wherein the outer shell includes an opening configuration sized and shaped to permit a user's fingers to enter the compartment and grasp the writing instrument.

2. The interactive package of claim 1, wherein the opening configuration includes two openings sized and shaped to permit a finger and a thumb of a user to enter and grasp the writing instrument without otherwise substantially touching the outer shell, mount, or back support.

3. The interactive package of claim 2, wherein the back support further comprises a hanging mechanism connected with the first end for hanging the package on a shelf.

4. The interactive package of claim 3, wherein the back support is formed of a material selected from a group consisting of plastic, paper, or cardboard.

5. The interactive package of claim 4, wherein the back support is made from a clear plastic.

6. The interactive package of claim 5, wherein the mount is formed to frictionally fit between the back support and the outer shell.

7. The interactive package of claim 6, wherein the mount is formed in a triangular shape.

8. The interactive package of claim 7, wherein the first portion of the mount and second portion of the mount are formed separately, and wherein the first portion of the mount is connected with the first end of the back support, and wherein the second portion of the mount is connected with the second end of the back support.

9. The interactive package of claim 8, wherein the first portion of the mount further comprises an indentation to frictionally fit the non-writing end of the writing instrument, and wherein the second portion of the mount further comprises an indentation to frictionally fit the writing end of the writing instrument, such that the writing instrument is mounted between the two indentations.

10. The interactive package of claim 9, wherein the indentation of the first portion and the indentation of the second portion of the mount are centered between the back support and the outer shell, such that when the writing instrument is mounted it appears to float within the package.

11. The interactive package of claim 10, wherein the mount is formed of a material selected from a group consisting of plastic, paper, or cardboard.

12. The interactive package of claim 11, wherein the back support is made from a clear plastic.

13. The interactive package of claim 12, wherein the outer shell is formed to frictionally fit the mount.

14. The interactive package of claim 13, wherein the outer shell is connected with the back support.

15. The interactive package of claim 14, wherein the openings in the outer shell are formed in locations that allow a user to grip the writing instrument without substantially touching the package.

16. The interactive package of claim 15, wherein both the first portion and the second portion of the mount are connected with the back support.

17. The interactive package of claim 16, wherein the back support and the outer shell are integrally formed as a single piece.

18. The interactive package of claim 1, wherein the back support further comprises a hanging mechanism connected with the first end for hanging the package on a shelf.

19. The interactive package of claim 1, wherein the back support is formed of a material selected from a group consisting of plastic, paper, or cardboard.

20. The interactive package of claim 1, wherein the back support is made from a clear plastic.

21. The interactive package of claim 1, wherein the mount is formed to frictionally fit between the back support and the outer shell.

22. The interactive package of claim 1, wherein the mount is formed in a triangular shape.

23. The interactive package of claim 1, wherein the first portion of the mount and second portion of the mount are formed separately, and wherein the first portion of the mount is connected with the first end of the back support, and wherein the second portion of the mount is connected with the second end of the back support.

24. The interactive package of claim 1, wherein the first portion of the mount further comprises an indentation to frictionally fit the non-writing end of the writing instrument, and wherein the second portion of the mount further comprises an indentation to frictionally fit the writing end of the writing instrument, such that the writing instrument is mounted between the two indentations.

25. The interactive package of claim 24, wherein the indentation of the first portion and the indentation of the second portion of the mount are centered between the back support and the outer shell, such that when the writing instrument is mounted it appears to float within the package.

26. The interactive package of claim 1, wherein the mount is formed of a material selected from a group consisting of plastic, paper, or cardboard.

27. The interactive package of claim 1, wherein the back support is made from a clear plastic.

28. The interactive package of claim 1, wherein the outer shell is formed to frictionally fit the mount.

29. The interactive package of claim 1, wherein the outer shell is connected with the back support.

30. The interactive package of claim 1, wherein the openings in the outer shell are formed in locations that allow a user to grip the writing instrument without substantially touching the package.

31. The interactive package of claim 1, wherein both the first portion and the second portion of the mount are connected with the back support.

32. The interactive package of claim 1, wherein the back support and the outer shell are integrally formed as a single piece.

33. A method for forming an interactive package for a writing instrument, the method comprising acts of:
forming a back support with a first end and a second end;
connecting an outer shell with the back support to define a compartment in combination with the back support;
positioning a mount in the compartment for supporting a writing instrument, wherein the mount comprises a first portion and a second portion, and wherein the writing instrument comprises a writing end and a non-writing end, and wherein the first portion of the mount is formed to mount the non-writing end of the writing instrument, and wherein the second portion of the mount is formed to mount the writing end of the writing instrument; and
wherein the outer shell is connected with the back support such that it covers the mount and supported writing instrument to securely protect the writing instrument, and wherein the outer shell comprises an opening configuration sized and shaped to permit a user's fingers to enter and grasp the writing instrument without otherwise touching the outer shell, mount, or back support.
